(19) United States
(12) Patent Application Publication
(10) Pub. No.: US 2011/0161428 A1
(43) Pub. Date: Jun. 30, 2011

(54) TWO-WAY DATA AND RESOURCES SHARING METHOD

(75) Inventor: Chia-Che HU, Taipei (TW)

(73) Assignee: EZPNP TECHNOLOGIES CORP.

(21) Appl. No.: 12/647,928

(22) Filed: Dec. 28, 2009

(51) Int. Cl. G06F 15/16

(52) U.S. Cl. 709/206; 709/208

(57) ABSTRACT

A two-way data and resources sharing method is disclosed. A sharing apparatus is provided to connect two computers for establishing two-way communication link between two computers. Firstly, a computer is configured as a master computer and the other computer is configured as a slave computer. The master computer and slave computer send a request instruction for executing data transfer, data synchronization or data sharing via an operating application installed in the master computer. The corresponding instructions requested are respectively executed on the connected two computers.

### BACKGROUND OF THE INVENTION

1. Field of the Invention

The present invention generally relates to computer sharing method, in particular, relates to a two-way sharing method between two computers.

2. Description of Prior Art

In this digital era, various electronics devices are provided to bring more conveniences to people's lives, where personal computers are considered the most important and dispersible among all.

With the industry development and breakthrough of semiconductor processes, pricing of personal computers is lower yet the function is more. As a result, many users use several computers at the same time to meet demands of various domains. Typically, a user uses a low end computer having limited hardware resources for document processing, uses a high end computer having powerful hardware resources to execute games, play audio/video files or edit images. Further, the user may use a portable computer for working mobile. Several computers provide sufficient hardware resources applied to specifically to meet various demands of the user in each domain.

Nonetheless, there are data frequent used across several computers used to meet different purposes. Or there are needs to transfer data among several computers owned by the same user. For example, when the user carries a portable computer out for business, the user has to duplicate the file processed in the low end computer and transfer the file to the portable computer so that the file can be used or displayed in business talks. In another example, if the user downloads a film with the low end computer or the portable computer and desires to watch the file on the high end computer; the user has to transfer the film to the high end computer so that the film is played with better audio/video effects. There are also users concerning about potential data loss caused by hardware malfunction and making data backup regularly. These users keep a copy of the important data in all of their computers and synchronize the data to lower the data loss risk caused by unexpected hardware malfunctions.

In order to address the above mentioned data transfer, most users transfer file via portable mediums (ex: an optical disc or portable drive) or internet by copying selected data from a source computer and save the data in the target computer. The method to transfer a file via portable computer involves complicated steps and long execution time as a result of limited transfer speed. In addition, there are also potential hidden risks about respective medium for data transfer leading to data loss. Further, the method to transfer via internet is risky in that the data may be hacked or infected with viruses during transfer to cause damage to the computers.

Moreover, in addition to data transfer and synchronization issues, the hardware upgrade is another difficult issue the user having several computers has to deal with. For example, typically, a wireless network card is an optional purchase items in a desk top computer but default item in a portable. However, an optical drive is an optional item in a portable computer but default item in a desk top computer to keep a portable computer slim and light. As a result, it can be a hard decision to make for the user whether it is a wiser idea to additionally add optical drive to a portable computer and wireless network card to a desk top computer.

To sum up the above, it is desirable to provide a sharing method for sharing data and hardware resources among a plurality of computers which is advantageous to boost development of related computer component industries.

### SUMMARY OF THE INVENTION

The objective of the invention is to provide a two-way data and resources sharing method for connecting two computers via a sharing apparatus in order to perform two-way data transfer, data synchronization, or computer peripheral hardware sharing between two computers.

In order to achieve the above objective, two computers are connected via a sharing apparatus to connect two computers for establishing two-way communication link between two computers according to the present invention. A computer is configured as a master computer and the other computer is configured as a slave computer. The master computer and slave computer send a request instruction for executing data transfer, data synchronization or data sharing via an operating application installed in the master computer. The corresponding instructions requested are respectively executed on the connected two computers.

Compare with prior art, advantages offered by the method of the present invention are two computers are connected directly via a sharing apparatus to perform two-way data transfer and data synchronization without an internet or an additional storage medium. Moreover, the link offers hardware resources sharing of the computers such that two computers have access to hardware resources of each other and cost to install the same component on each computer is waived.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a block diagram of a preferred embodiment according to the present invention;

FIG. 2 is a general sharing flowchart of a preferred embodiment according to the present invention;

FIG. 3 is a data transfer flowchart of a preferred embodiment according to the present invention;

FIG. 4 is a data synchronization flowchart of a preferred embodiment according to the present invention; and

FIG. 5 is a hardware sharing flowchart of a preferred embodiment according to the present invention.

### DETAILED DESCRIPTION OF THE INVENTION

In cooperation with attached drawings, the technical contents and detailed description of the present invention are described thereinafter according to a preferable embodiment, being not used to limit its executing scope. Any equivalent variation and modification made according to appended claims is all covered by the claims claimed by the present invention.

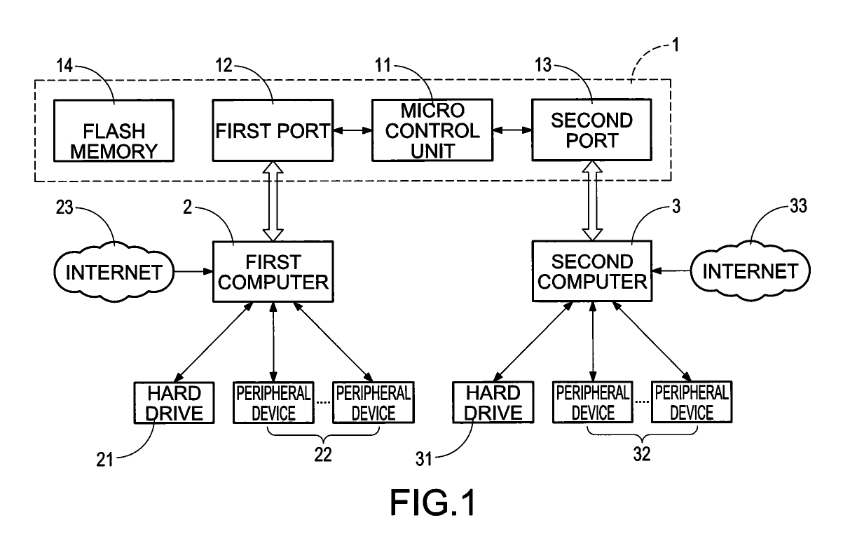

FIG. 1 is a block diagram of a preferred embodiment according to the present invention. As shown in the diagram, a first computer 2 and a second computer 3 are connected via a sharing apparatus 1 in the method of the present invention. The sharing apparatus 1 has a micro control unit (MCU) 11, a first port 12 and a second port 13. The first port 12 is used for connecting with the first computer 2, and the second port 13 is used for connecting with the second computer 3. The two ports 12, 13 are universal serial bus (USB) ports, connecting with the computers 2, 3 with transfer cable or adapter compatible with USB protocol offering power required for operation to the sharing apparatus 1 by the first computer 2 or the second computer 3. Specifically, the ports 12, 13 are USB 2.0 ports implemented by USB 2.0 serial interface engine (SIE) and USB 2.0 transceiver of USB 2.0 transceiver macrocell interface (UTMI), but the scope of the present invention is not limited to the embodiment.

The computers 2, 3 each respectively comprises a hard drive 21, 31 installed with an operation system (OS) and used for data storage. The computers 2, 3 each respectively connects with peripheral devices 22, 32, such as an optical drive, a printer, a keyboard and a mouse; and each respectively connects to internet 23, 33 with respective hardware resources. When the computers 2, 3 are connected via the sharing apparatus 1, the first computer 2 is enabled to access to the data in the hard drive 31 of the second computer 3 via the sharing apparatus 1, or to perform data transfer from the hard drive 21 of the first computer 2 to the second computer 3. Further, the first computer 2 is enabled to perform data synchronization of data in a folder and data of email data between the computers 2, 3. Also, the first computer 2 is enabled to share with and the second computer 3 of peripheral devices 32 of the second computer 3 with the sharing apparatus 1. Similarly, the second computer 3 is connected to the first computer 2 and enabled to access data in first computer 2 and perform data synchronization with the first computer 2 via the sharing apparatus 1; or and the first computer 2 is enabled to share peripheral devices 22 connected with the first computer 2.

It should be noted as long as one of the computers 2, 3 is respectively connected to internet 23, 33, the other compute which is not connected to internet is enabled to share network resource such as internet access account and bandwidth of the computer connected to the internet via the sharing apparatus 1.

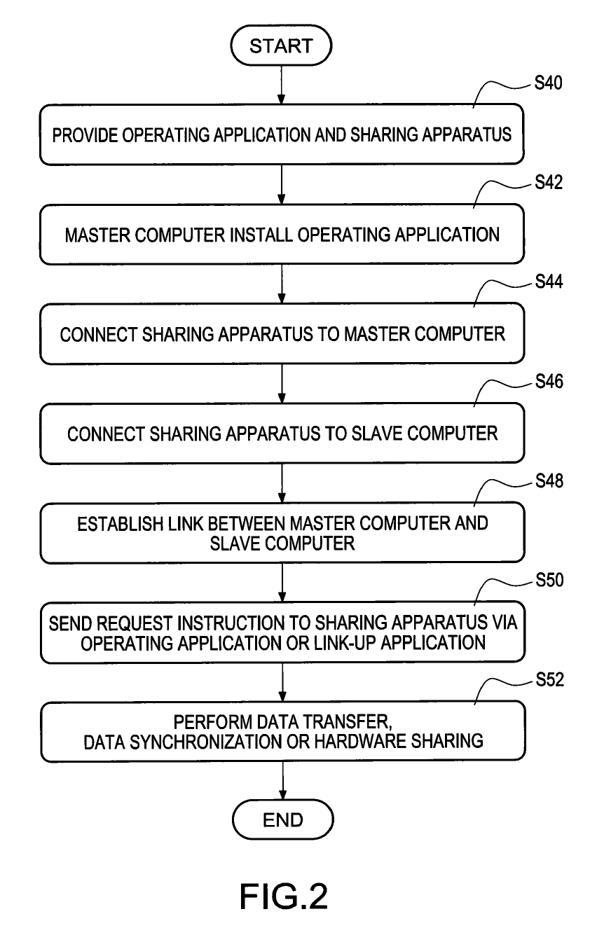

FIG. 2 is a general sharing flowchart of a preferred embodiment according to the present invention. Firstly, the sharing apparatus 1 and an operating application working with the sharing apparatus 1 are provided (step S40). And, one of the computers 2, 3 is configured as the master computer, and the operating application is installed in the master computer (step S42). For the convenience for explanation, the first computer 2 referred as the master computer 2, the second computer 3 is referred as a slave computer3.

It should be noted that the operating application is used as a driver of the sharing apparatus 1 and an application offering operating interface of the sharing apparatus 1 to a user. The operating application can be saved in an optical disc (not shown), and installed via an optical drive connected to the master computer 2. Moreover, the operating application can be saved in a flash memory 14 in the sharing apparatus 1 and installed automatically in the master computer 2 by the sharing apparatus when the link between the sharing apparatus 1 and the master computer 2 is connected. In addition to the status that the operating application is installed in the master computer 2, the operating application can be a green application which is deleted when the connection between the master computer 2 and the sharing apparatus 1 terminates, but the scope of the present invention is not limited to the embodiment.

Following the operating application is installed in the master computer 2, the first port 12 of the sharing apparatus 1 is connected to the master computer 2 (step S44). Thus, the master computer 2 offers power to the sharing apparatus 1 required to trigger operation of the micro control unit 11 in the sharing apparatus 1. Following the connecting to the master computer 2, the sharing apparatus 1 detects the connected master computer 2, and the master computer 2 automatically executes the installed operating application. Following step S44, the second port 13 of the sharing apparatus 1 is connected to the slave computer3 (step S46). The sharing apparatus 1 detects the connected slave computer 3. The operating application installed in the master computer 2 is enabled to install a virtual optical drive in the slave computer 3 with the sharing apparatus 1. A link-up application in the virtual optical drive is automatically executed for correspondingly operating with the operating application installed in the master computer 2 to establish the link between the master computer 2 and the slave computer 3 (step S48). Thus, it is not required to install any application in the slave computer 3. The slave computer 3 establishes the link with the master computer 2 via the link-up application of the virtual optical drive and executes the operating application. However, when the connection of the computers 2, 3 terminates, or when the ports 12, 13 of the sharing apparatus 1 are unplugged from the computers 2, 3, the virtual optical drive and the link-up application are deleted from the slave computer 3. Also, if the operating application is a green application, the operating application, the virtual optical drive and the link-up application are simultaneously deleted.

Following the link of the computers 2, 3 are established, the computers 2, 3 communicates with each other via the operating application or the link-up application in the virtual optical drive to sends request instructions to the sharing apparatus 1 (step S50). Thus, the sharing apparatus 1 performs data transfer, data synchronization, or hardware resource sharing the computers 2, 3 based request instructions on received from the master computer 2 or the slave computer 3 (step S52).

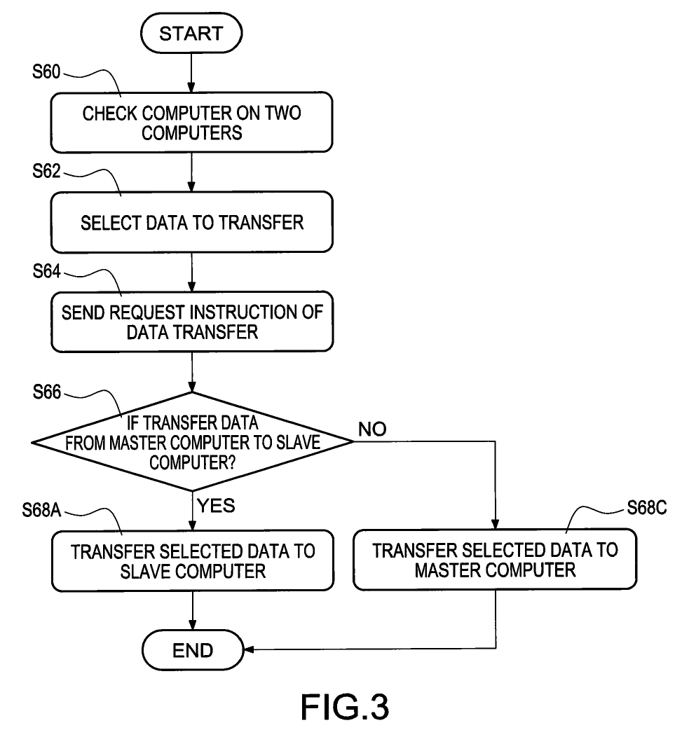

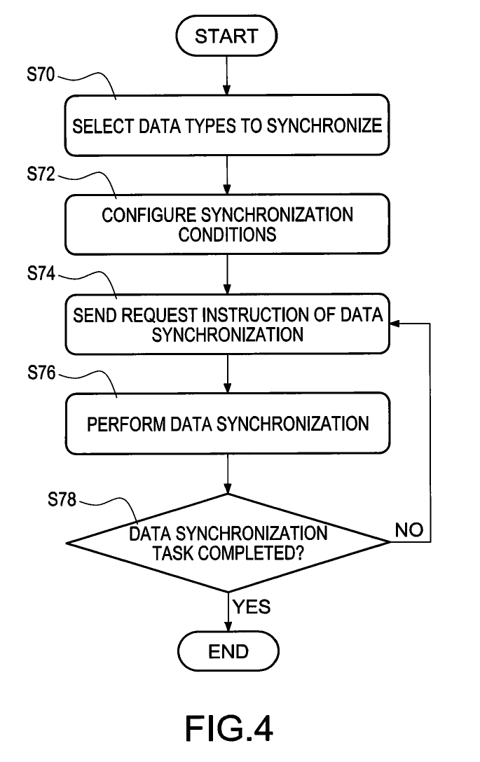

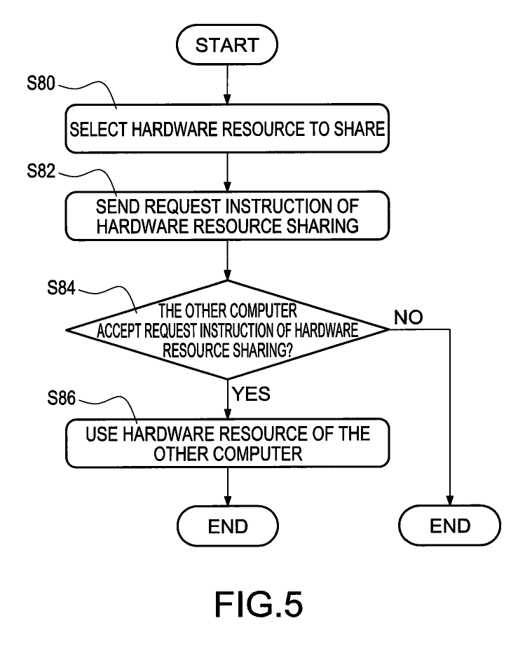

FIG. 3, FIG. 4 and FIG. 5 are flowcharts illustrating the sharing method of an embodiment according to the present invention respectively demonstrating operation steps data transfer, data synchronization, and hardware sharing between the computers 2, 3. Detailed steps are described along with the flowcharts in the following.

FIG. 3 is a data transfer flowchart of a preferred embodiment according to the present invention. When the link in the FIG. 2 is successfully established, one of the computers 2, 3 is allowed to check the data saved in the hard drive of the other computer via applications such as My Computer, Windows Explorer or the operating application and the link-up application of the present invention the present invention (step S60). Following data checking, if one of the computers 2, 3 determines to transfer data or files, the computer selects the data to transfer (step S62). One of the computers 2, 3 sends a request instruction of data transfer to the sharing apparatus 1 with the operating application or the link-up application (step S64). The master computer 2 may request to transfer data from the master computer 2 to the slave computer3, or request to transfer data from the slave computer 3 to the master computer 2. Similarly, the slave computer 3 can also perform data transfer in the same two-way manner. Accordingly, the master computer 2 and the slave computer3 are considered two computer ends with equal capability to access to one another.

As the request instruction is received by the sharing apparatus 1, the sharing apparatus determines if the request instruction requests a data transfer from the master computer 2 to the slave computer 3 (step S66). If yes, then the step moves to the step S68A, the selected data is transferred from the master computer 2 to the slave computer3. If no in step S66, then the step moves to the step S68C, selected data is transferred from the slave computer3 to the master computer 2.

FIG. 4 is a data synchronization flowchart of a preferred embodiment according to the present invention, where one of the master computer 2 or the slave computer 3 performs data synchronization. Firstly, data types to synchronize at the two computers are selected (step S70), in other words, to set up the types of data or files to perform synchronization, for example, selecting folders of any division of hard drives 21, 31 or email data (Outlook application). The data synchronization types are selected and then the step moves to configure one or more than one synchronization task on selected data types (step S72). Each synchronization task is configured with different synchronization conditions, for example to columns to perform synchronization, synchronization means of column synchronization, and time restriction for editing (establishing) synchronization files (refers details in the following). While synchronization types and task are all configured, one of the computers 2, 3 sends request instruction of data synchronization (step S74). Next, data synchronization is executed with the sharing apparatus 1 (step S76). Then, the sharing apparatus 1 determines that if the synchronization task is executed completely (step S78). If no, the method moves back to the step S74 until all synchronization tasks are executed completely.

As mentioned above, the data synchronization operation according to the present invention allows various synchronization conditions of each synchronization task, for example, “task 1” is a synchronization task for synchronizing emails and the synchronization configurations are:

1. the synchronization column is Inbox;

2. when process on data of the same file name, the data of the master computer 2 replaces the data of the slave computer 3.

For another example, the synchronization configurations of “task 2” are:

1. the synchronization column is Contact;

2. when process on data of the same file name, the data of the slave computer 3 replaces the data of the master computer 2; and

3. synchronize only on data established after certain date expressed in form of dd, mm, yyyy.

The above examples are used for illustrative purpose to give detailed operation steps of the data synchronization of the present invention and should not be limits to the scope of the present invention.

FIG. 5 is a hardware sharing flowchart of a preferred embodiment according to the present invention. Firstly, one of the computers 2, 3 selects the hardware resource to share (step S80), and sends a request instruction of hardware sharing to the sharing apparatus 1 (step S82). The sharing apparatus 1 receives the request instruction of hardware sharing and inquires the other computer if request instruction of hardware sharing is accepted (step S84). If the request instruction of hardware sharing is accepted by the other computer, the computer selects the hardware resource to share in the step S80 is allowed to use the hardware resource of the other computer (step S86).

For example, if the master computer 2 selects to perform hardware sharing of network resource request sharing and sends a request instruction of hardware sharing in the step. Then, the sharing apparatus 1 inquires if network resource sharing request is accepted by the slave computer 3. If the slave computer 3 accepts to perform network resource sharing in the step S84, the master computer 2 is allowed to share network resource of the slave computer 3 with the sharing apparatus 1. Hence, the master computer 2 is connected to the internet via the slave computer 3. It should be noted that if both computers 2, 3 are not connected to the internet, either the computers 2, 3 should not select the option to make hardware sharing request of network resource in the step S80.

For example, if the master computer 2 determines to perform hardware sharing of an optical drive, and sends a request instruction of hardware sharing in the step S80, the sharing apparatus 1 inquire the slave computer 3 if the sharing request of the optical drive is accepted in the step S84. If the sharing request is accepted by the slave computer 3, the master computer 2 is allowed to connect to the slave computer 3 with the sharing apparatus 1 and access to the content of the optical disc in the optical drive of the slave computer 3. And if the master computer 2 determines to request hardware sharing of other peripherals such as a printer, a keyboard or a mouse etc. . . . in the step S80, the following steps follows the above to share the specific peripheral requested. The master computer 2 is connected to the slave computer3 via the sharing apparatus 1 and shares the peripherals such as the printer, the keyboard and the mouse connected to the slave computer 3.

It should be mentioned that when the computers 2, 3 are inter-connected with the sharing apparatus 1, both computers are allowed to perform data transfer, data synchronization, or hardware sharing via an application (the master computer 2 via the operating application, and the slave computer 3 via the link-up application in the virtual optical drive). The method of the present invention does not interfere with the normal operations of a computer. For example, the master computer 2 accessing to the network resource of the slave computer 3 with the sharing apparatus 1 does not affect the connection to internet of the slave computer 3.

As the skilled person will appreciate, various changes and modifications can be made to the described embodiments. It is intended to include all such variations, modifications and equivalents which fall within the scope of the invention, as defined in the accompanying claims.

What is claimed is:

1. A two-way data and resources sharing method, a sharing apparatus provided to two computers for two-way sharing the data and the resources, the method comprising:
a) configuring the computers as a master computer and a slave computer;
b) installing an operating application at the master computer;
c) connecting the master computer and the slave computer via the sharing apparatus;
d) launching the operating application and setting up a virtual optical drive with the sharing apparatus at the slave computer; and
e) executing a link-up application in the virtual optical drive at the slave computer operating correspondingly with the operating application to establish the link between the two computers.

2. The two-way data and resources sharing method of claim 1, wherein the method further comprises a step:
f) executing data transfer, data synchronization or hardware sharing via the operating application or the link-up application at the two computers.

3. The two-way data and resources sharing method of claim 2, wherein when the computers perform data transfer, the method further comprises below steps following the step f:
f11) selecting data to transfer at the two computers;
f12) sending a data transfer instruction to the sharing apparatus;
f13) determining if the instruction requesting the master computer transfers data to the slave computer at the sharing apparatus;
f14) following step f13, if yes, the master computer transferring the selected data to the slave computer; and
f15) following step f13, if no, the slave computer transferring the selected data to the master computer.

4. The two-way data and resources sharing method of claim 2, wherein when the computers perform data transfer, the method further comprises below steps following the step f:
f21) selecting data types to synchronize at the two computers;
f22) configuring a synchronization task based the data types to synchronize;
f23) sending a data synchronization instruction to the sharing apparatus;
f24) executing data synchronization with the sharing apparatus at the two computers;
f25) determining if the synchronization task execution is completed at the sharing apparatus; and
f26) following step f25, if no, repeating execution from the step f23 to the step f25.

5. The two-way data and resources sharing method of claim 4, wherein the data types to synchronize is data folder or email data.

6. The two-way data and resources sharing method of claim 5, wherein the email data is email data of Outlook operating application under a Windows operating system.

7. The two-way data and resources sharing method of claim 4, wherein the synchronization task comprises one or more than one synchronization conditions.

8. The two-way data and resources sharing method of claim 7, wherein the synchronization conditions comprises columns to synchronize, synchronization means of the columns, and edited time of the synchronization files.

9. The two-way data and resources sharing method of claim 2, wherein when the computers perform hardware sharing, the step f further comprises following steps:
f31) selecting a hardware to share by one of the two computers;
f32) sending a hardware sharing instruction to the sharing apparatus;
f33) following step f32, the computer performing the selection in step f31 using the selected hardware connected to the other computer with the sharing apparatus;

10. The two-way data and resources sharing method of claim 9, wherein the selected hardware connected to the other computer is a optical drive in step f33.

11. The two-way data and resources sharing method of claim 9, wherein the selected hardware connected to the other computer is a printer in step f33.

12. The two-way data and resources sharing method of claim 9, wherein the selected hardware connected to the other computer is a keyboard in step f33.

13. The two-way data and resources sharing method of claim 9, wherein the selected hardware connected to the other computer is a mouse in step f33.

14. The two-way data and resources sharing method of claim 9, wherein the selected hardware connected to the other computer is a network resource in step f33.

15. The two-way data and resources sharing method of claim 1, wherein the sharing apparatus are connected to the computers via two universal serial bus ports in step c.

16. The two-way data and resources sharing method of claim 1, wherein the sharing apparatus are connected to the computers via two universal serial bus 2.0 ports in step c.

17. The two-way data and resources sharing method of claim 1, wherein the virtual optical drive and the link-up application at the slave computer are automatically deleted when the connection between the master computer and the slave computer terminates.

18. The two-way data and resources sharing method of claim 1, wherein the operating application is saved in a flash memory of the sharing apparatus, and installed automatically in the master computer by the sharing apparatus when the link between the sharing apparatus and the master computer is connected.

19. The two-way data and resources sharing method of claim 18, wherein the operating application is a green application and is deleted when the connection between the master computer and the sharing apparatus terminates.
